(19) United States
(12) Patent Application Publication
(10) Pub. No.: US 2005/0222884 A1
(43) Pub. Date: Oct. 6, 2005

(54) Capacity planning of resources

(76) Inventors: Ralf Ehret, Walldorf (DE); Achim Magel, Bad Schoenborn (DE); Andreas Bold, Ludwigshafen (DE); Hans-Georg Beuter, Angelbachtal (DE)

Correspondence Address: FISH & RICHARDSON, P.C., PO BOX 1022, MINNEAPOLIS, MN, 55440-1022, US

(21) Appl. No.: 10/815,131

(22) Filed: Mar. 31, 2004

(51) Int. Cl. G06F 17/60

(52) U.S. Cl. 705/8

(57) ABSTRACT

Some implementations provide a resource planning system for receiving a first scheduling request for a resource's time. This first scheduling request may include a date range and the estimated amount of time needed from the resource, but does not necessarily include concrete date and time facts. This first scheduling request may be refined by a second scheduling request, which specifies concrete date and time facts to schedule a portion of the resource's time that was originally requested by the first scheduling request.

### TECHNICAL FIELD

This invention relates to capacity planning of resources, such as planning of a resource's time.

### BACKGROUND

Businesses of all types generally attempt to use their existing resources in the most efficient and organized manner. For example, a professional consulting business may attempt to fill the schedule of each consultant (a resource) with client-related work between the hours of 8:00 AM and 5:00 PM so as to use the full capacity of time provided by that consultant. Similarly, a technology service business may attempt to schedule a skilled technician (a resource) as a field service technician (servicing/repairing products at various locations) two days per week and as a call center agent (providing technical support via telephone or internet communications) three days per week. Such a schedule for the skilled technician may efficiently distribute the technician's capacity of time. In another example, a manufacturing plant may use a single machine (a resource) to manufacture several different products, but the machine must be shut down for a period of time when new tooling must be set-up for the manufacture each of the different products. Thus, the machine's capacity to build the different products may be efficiently scheduled by reducing the number of tooling changes.

Conventional scheduling systems may permit an operator to schedule a resource's time to an assignment having concrete date and time facts. For example, a conventional system may schedule an assignment to a skilled technician to work as a field service technician on Monday from 9:00 AM to 6:00 PM and then to work as a call center agent on Tuesday from 8:00 AM to 5:00 PM. The concrete date and time facts for this assignment permit the system to reserve the worker's time on Monday and Tuesday for the specified tasks. In another example, a conventional system may schedule an assignment for a professional consultant to work on a client's project from 8:00 AM to 5:00 PM on Monday, June 16. Because the date and time facts are concrete, the conventional system may reserve the consultant's time.

Problems arise when a request for a resource's time does not include concrete date and time facts. If, for example, a request for a consultant's time specifying only that the consultant must spend twenty hours in the month of April working on a particular project, the required concrete date and time facts would be lacking. Some conventional systems may not be able to handle such a non-concrete assignment. Other may automatically schedule such a non-concrete assignment in a potentially inefficient manner (e.g., scheduling one hour per day for the first twenty work days in April even though the consultant is already scheduled at 100% capacity on one or more of those days).

### SUMMARY

Certain implementations of the invention provide a resource planning system or method for receiving a scheduling request for a resource's time where the scheduling request includes a date range and the estimated amount of time needed from the resource, but does not include concrete date and time facts. This first scheduling request may be refined by a second scheduling request, which specifies concrete date and time facts to schedule a portion of the resource's time that was originally requested by the first scheduling request. In such implementations, the resource's time may be scheduled in an efficient manner without over-scheduling or double-booking the resource's time.

In one implementation, a method of scheduling use of a resource includes receiving a first scheduling request for a resource. The first scheduling request specifies that the resource is to be scheduled for a requested amount of time sometime within a requested time period-the requested amount of time being less than a maximum time amount that the resource is available during the requested time period. The method further includes receiving a second scheduling request for the resource that refines the first scheduling request. The second scheduling request specifies that a portion of the requested amount of time is to be scheduled in a specific time slot within the requested time period. The method also includes scheduling in an electronic schedule the portion of the requested amount of time in the specific time slot, and scheduling in the electronic schedule a remaining portion of the requested amount of time within the requested time period except within the specific time slot.

The systems and techniques described herein may provide any or all of the following advantages. Improved scheduling of a resource. Improved determination of a resource's workload. Improved use of a scheduling program. Improved scheduling of concrete and non-concrete requests for use of a resource. Providing that the impact of a non-concrete scheduling request on a resource's schedule properly takes into account a concrete refinement of that non-concrete request. Providing that, when a non-concrete scheduling request is refined by a concrete request, the remainder of the non-concrete request is properly distributed in the resource's schedule. Providing that, when a non-concrete scheduling request is refined by a concrete request, the remainder of the non-concrete request is distributed in the resource's schedule to avoid overscheduling the resource.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of a computer system in accordance with one implementation of the invention.

FIGS. 2A-C are graphical representations of a resource's time capacity in accordance with an implementation of the invention.

FIGS. 3A-C are graphical representations of a resource's time capacity in accordance with another implementation.

FIG. 4 is a flow chart for the process of scheduling the use of a particular resource, in accordance with one implementation of the invention.

Like reference symbols in the various drawings indicate like elements.

### DETAILED DESCRIPTION

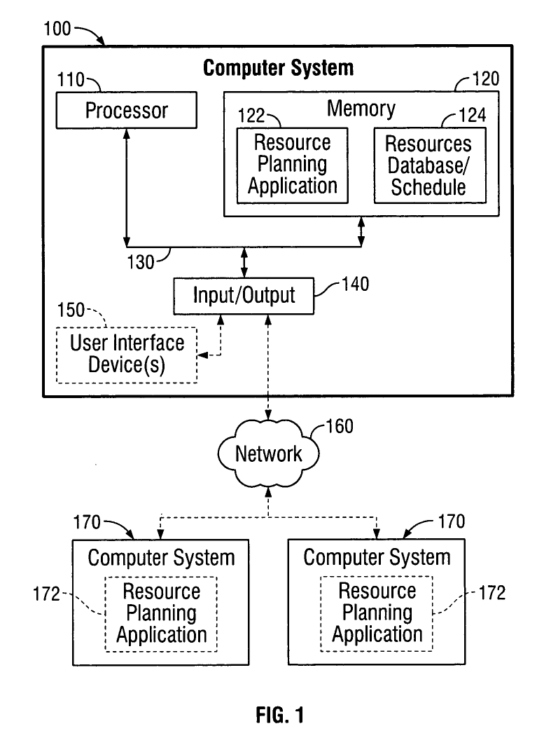

Referring to FIG. 1, a computer system 100 includes a processor 110 and memory 120 coupled to a computer bus 130 or other suitable interconnect. The memory 120 has a resource planning application 122 and a resource database 124 stored thereon. The resource planning application 122 is capable of receiving (e.g., includes executable instructions for receiving) information from the resource database 124 and capable of transmitting (e.g., includes executable instructions for transmitting) new information to the resource database 124. For example, the resource database 124 may include information on certain workers in a business and the time availability of those workers. In such a case, the resource planning application 122 is capable of receiving worker availability information from the resource database 124 so as to schedule a new assignment for that worker in a time slot of an electronic schedule. When the new assignment is scheduled, the worker's availability information in the resource database 124 is modified accordingly. In some implementations, a computer program product installed onto the memory 120 may include the resource planning application 122, of which the electronic schedule is a sub-application. Alternatively, the electronic schedule may be a separate application stored on the memory 120. In the examples below, the scheduling of a resource is what determines the use of that resource. Alternatively, scheduling may be used to estimate the utilization of the resource; that is, to determine the workload of the resource although the scheduling does not actually govern the use of the resource. Thus, the systems and techniques described herein may be used for directly managing a resource's workload or for determining the resource's workload.

The resource planning application 122 is capable of receiving requests for a resource's time. For example, a consulting firm may use the resource planning application 122 to manage the schedules of consultants (resources). In such a situation, a client or a scheduling manager may request that a particular consultant—any consultant having particular qualifications—work on project for a certain number of hours. The resource planning application 122 may receive non-concrete requests that include a date range and the estimated amount of time needed from the resource, but does not include concrete date and time facts. For example, the non-concrete request may ask for a consultant to work for forty hours (i.e., the estimated amount of time) on a project at any time in the month of January (i.e., date range of January 1-31). This non-concrete request may be later refined by a subsequent concrete request, which specifies concrete date and time facts to reserve at least a portion of the resource's time that was originally requested by the non-concrete request. Continuing with the previous example, the concrete request may ask for the consultant to work on a particular aspect of the project for eight hours on January 15 during the time slot of 8:00 AM to 4:00 PM, thus permitting the remaining thirty-two hours from the original request to be served on other days in January. By permitting the resource's time to be initially reserved with a non-concrete request and then later refined with a concrete request, the resource's time may be scheduled in an efficient manner without over-scheduling or double-booking.

Still referring to FIG. 1, the processor 110 and memory 120 are interconnected to at least one I/O (input/output) device 140 in the computer system 100. The I/O device 140 can be connected with one or more user interface devices 150, such as a keyboard, mouse, display, or the like. The user interface devices 150 permit a user of the computer system 100 to interact with various components of the computer system 100 or permit a user to cause certain processes to be executed. The I/O device 140 may be connected to a network 160, such as the Internet or a local area network. The connection with the network 160 permits the computer system 100 to communicate with one or more remote computer systems 170. For example, a remote computer system 170 may include a resource planning application 172 similar to the previously described application 122. In such an implementation, the resource planning application 172 of the remote computer system 170 may receive information from the resource database 124 via the network connection. Thus, the resource planning application 172 may be capable of receiving information from the resource database 124 and capable of transmitting new information to the resource database 124.

In some implementations, the computer system 100 may be a server system and the remote computer system(s) 170 may be remote workstations with which the server system 100 maintains network connections. The server system 100 includes memory that has the resource planning application 122 and the resource database 124 stored thereon. The resource planning application 122 and the resource planning application 172 of the remote workstation system 170 may receive information from the database 124 and likewise transmit information to the database 124. Such an implementation may be used, for example, by businesses where more than one manager or human resources professional has the authority to schedule a worker's time. In such circumstances, that worker's availability information is stored in the resource database 124, and each manager may use a personal workstation system 170 to schedule a portion of that worker's available time using a resource planning application 172. Because all of the resource planning applications 172 (at the different workstation systems 170) receive information from one resource database 124 on the server system 100, a manager at one workstation system 170 may have access to the worker's time availability information as modified by another manager on another workstation system 170. In one example, a manager that intends to schedule a service technician to work in a technical support call center on either Thursday or Friday would be able to know that the service technician was previously scheduled by a different manager to work as a field service technician on Thursday.

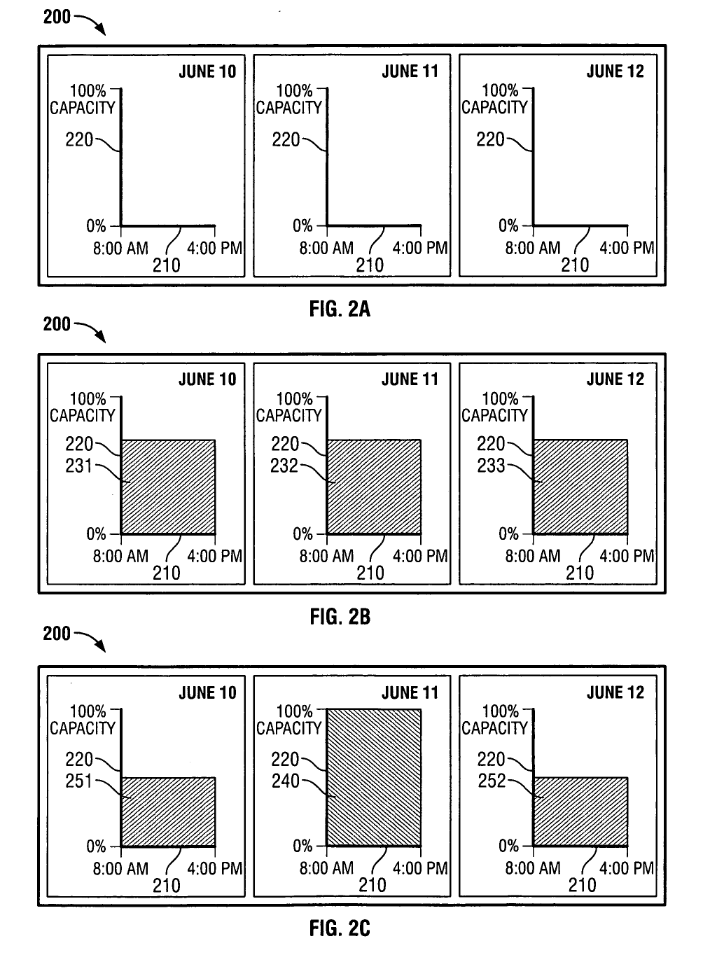

FIGS. 2A-C are a conceptual example illustrating operations in a resource planning application. Particularly, these figures show how a non-concrete request for a resource's time may be received and scheduled, followed by the receipt and scheduling of a concrete refinement thereof. In this example, the resource's total availability over three days—here, June 10, 11, and 12—is schematically illustrated in date range 200. The number of hours that can be scheduled each day are measured by the horizontal axis 210—in this example, the resource is available for eight hours each day (8:00 AM-1:00 PM). The amount of the resource's capacity that is being used is measured against the vertical axis 220, in this example marked with 0% and 100%) levels. Such characterizations of the resource's available time may be included with the availability information of the resource database 124 or may be implemented by the electronic schedule for that resource.

In the graphic representation of the resource's capacity, the resource would be fully utilized if scheduled to 100% capacity for each day. For example, if a professional consultant (a resource) is available for eight hours on June 10, and a client requests that the consultant work on a project for eight hours that day, the resource is fully utilized (100%) capacity. On the other hand, if the consultant is available for eight hours on June 10, but no clients have requested a portion of the consultant's available time, the resource is not fully utilized for that day (0% capacity). If a client has requested the consultant to work on a project that requires only four hours on June 10, the impact on the consultant's availability would be equivalent to the resource being used at 50% capacity for that day ([4 hours of scheduled time]/[8 hours of available time]=50% use of total availability). Thus, the consultant would be able to spend four hours on the client's project while the remaining four hours would be available for another work project or, if no other project is scheduled, for doing the nonclient-related work (possibly, with no direct revenue to the business).

Referring to FIG. 2A, a resource has a total availability 210 of eight hours on each day between June 10 and June 12. In this example, the resource is available from 8:00 AM to 4:00 PM (eight hours of total availability) on each of the days, but the total availability 210 may be divided into arbitrary time periods that amount to eight hours. At this point, the availability information for this resource includes no scheduled assignments to complete on these days, so the resource is scheduled to be used at 0% capacity 220 on June 10-12. This availability information for the resource may be stored in a resource database (e.g., the database 124 from FIG. 1).

Referring to FIG. 2B, the resource planning application (e.g., the application 122 from FIG. 1) receives a non-concrete request for sixteen hours of service from the resource sometime on the dates of June 10-12. In one example where the resource is a professional consultant, such requests for the resource's time may come from a remote resource planning application 172 used by the consultant's client or by the consulting firm's scheduling manager. The request for the resource's time is non-concrete because it does not specify the exact allotment of hours for each day. Rather, it merely requests sixteen hours of the resource's time to be distributed sometime between June 10 and June 12. The resource planning application receives the availability information from the resource database to verify that the resource has available time on those dates (as graphically represented in FIG. 2A, the resource has a total of twenty-four available hours between the days of June 10-12). Because the resource had no other assignments scheduled for the three-day period 200, the resource planning application evenly distributes the non-concrete request into portions 231, 232, and 233 over the three-day period 200. The purpose of including the non-concrete request in the resource's schedule is to take into account the impact it will have on the availability of the resource. In this implementation, the non-concrete request is apportioned into 5 1/3 hours for each day so as to reserve a total of sixteen hours. In some embodiments, such an assignment may be scheduled in an electronic schedule that allots the 5 1/3 hours into actual time slots (e.g., 8:00 AM to 1:20 PM), thus reserving that time slot for the resource to serve/work on the desired task. Because the 5 1/3 hour portions 231, 232, and 233 are from a non-concrete request, the scheduled time slots may be modified to accommodate a subsequent concrete request (explained in more detail below). As shown in FIG. 2B, the non-concrete assignment has an impact on the resource's availability that is equivalent to the resource being used at 66.6% capacity for each day in the three-day range 200.

Referring to FIG. 2C, the resource planning application is capable of receiving a concrete request that is a refinement of the previously described non-concrete request. In this example, the refinement is a concrete request that specifies the resource must serve eight hours (out of the originally requested sixteen hours) on June 11 during the time slot of 8:00 AM to 4:00 PM. The resource planning application verifies with the availability information that the resource is available for the requested time intervals (e.g., by verifying that the resource does not have any concrete assignments scheduled in the requested time intervals), and then redistributes the resource's schedule. As shown in FIG. 2C, the resource planning application distributes the concrete request into a portion 240 on June 11. The portion 240 has different cross-hatching to distinguish it from the non-concrete portions 231, 232 and 233. In this example, the concrete portion 240 is scheduled in the electronic schedule according to the time slots specified in the concrete request (8:00 AM to 4:00 PM). The portion 240 accounts for the eight hours covered by the concrete request, which is a refinement of the sixteen hours originally requested as part of the non-concrete request.

When the non-concrete request (sixteen hours) is refined by the concrete request (eight hours), there are eight hours remaining from the non-concrete request. These hours need to be distributed in the date range 200 to give a realistic idea of how much of the resource's capacity is still available. If the remaining eight hours were distributed evenly throughout the three-day range 200, the resource would be scheduled in excess of its 100% capacity on June 11. The remaining eight hours are therefore scheduled while taking the portion 240 from the existing concrete assignment into account. That is, the eight hours of concrete assignment scheduled on June 11 are subtracted from the resource total availability, and the remainder of the non-concrete request (eight hours) is distributed elsewhere in the date range 200. In so doing, the resource planning application accounts for the portion 240 of time reserved by the concrete request and modifies the resource's availability information. Then, the resource planning application redistributes the remaining eight hours into portions 251 and 252 using the modified availability information. Thus, the resource planning application schedules the non-concrete portions 251 and 252 into the electronic schedule, but not in the time slots reserved by the concrete request.

As shown in FIG. 2C, the concrete request caused the resource to be scheduled at 100% capacity on June 11, so the resource's only available time in the three-day period 200 is the eight hours on June 10 and the eight hours on June 12. After accommodating for portion 240, the resource planning application redistributes the remaining eight hours into two portions 251 and 252, one for each day of June 10 and June 12. Each portion 251 and 252 corresponds to four hours of work, reserving a total of eight hours that equals the remaining eight hours from the original non-concrete request. As such, the non-concrete assignment and subsequent concrete refinement have an impact on the resource's availability that is equivalent to the resource being used at 50% capacity on June 10, 100% capacity on June 11, and 50% capacity on June 12. This availability information may be included in the resource database so that the resource's availability is accurately reflected when the next scheduling request is received by the resource planning application.

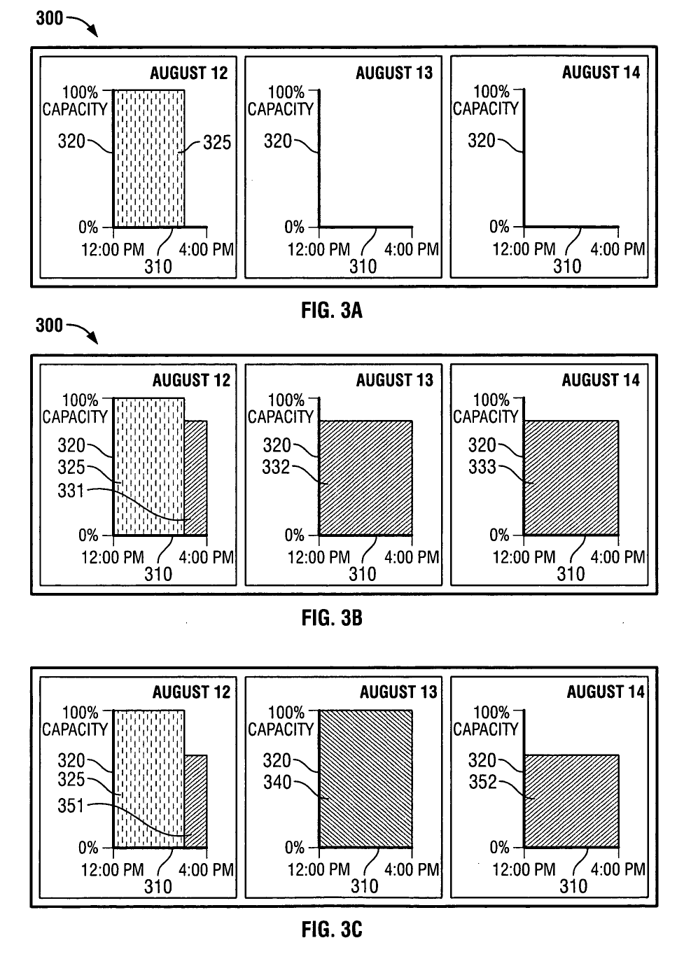

A non-concrete request can be handled also when a portion of the resource's time is already reserved due to a previously-accepted concrete request. The previously described FIGS. 2A-C were a conceptual example illustrating how a non-concrete request for a resource's time may be received and scheduled, followed by the receipt and scheduling of a concrete refinement thereof. FIGS. 3A-C are similar in that the number of hours that can be scheduled each day are measured by the horizontal axis 310, but in this example, the resource is available for four hours each day (12:00 PM-4:00 PM). FIGS. 3A-C are also similar to the previously described FIGS. 2A-C in that the amount of the resource's capacity that is being used is measured against the vertical axis 320.

As shown in FIG. 3A, the resource's total availability 310 is four hours for each day in the three-day period 300 between August 12 and August 14. In this example, the resource is available from 12:00 PM to 4:00 PM (four hours of total availability) on each of the days, but the total availability 210 may be divided into arbitrary time periods that amount to four hours. Before the resource planning application receives a non-concrete request for the resource's time over this date range 300, a separate concrete request for a portion 325 of the resource's time was previously accepted and scheduled. The previously-accepted portion 325 accounts for three hours of the resources time, and is scheduled in the electronic schedule, for example, in the time slot of 12:00-3:00 PM. The availability information for the resource, including the time reserved by the previously-accepted concrete request, may be stored in the resource database 124 (FIG. 1). According to the availability information at this point, the previously-accepted concrete request has an impact on the resource's availability that is equivalent to the resource being used at 100% for three hours on August 12, 0% on August 13, and 0% on August 14.

Referring to FIG. 3B, the resource planning application receives a non-concrete request for seven hours of the resource's services sometime on the dates of August 12-14. Rather than distributing the requested seven hours into three 2 1/3 hour portions (one equal portion for each day), which would cause the resource to be overbooked on August 12 (scheduled at 133% capacity), the resource planning application distributes the requested time into portions such that the resource is never scheduled to exceed 100% capacity on any day. Because the availability information shows that the available hours are not equal for each day in the three-day period 300, the requested seven hours is distributed into three non-concrete portions 331, 332, and 333 that are not all equal. The seven hours requested by the non-concrete request are distributed over the available time; that is, over one hour on August 12 and over the four available hours on each of August 13 and 14. The amount of time scheduled in each of these time slots is such that the impact of the non-concrete request is equal over the available hours (the portions 331, 332 and 333 have the same height.)

Referring to FIG. 3C, the resource planning application is capable of receiving a concrete request that is a subsequent refinement of the previously described non-concrete request for seven hours. In this implementation, the refinement is a concrete request that specifies the resource must serve four hours (out of the originally requested seven hours) on August 13 during the time slot of 12:00-4:00 PM. The resource planning application verifies that the resource is available for this requested time interval by referring to the availability information in the resource database. Because the only time reserved on August 13 was a portion 332 from the non-concrete request, of which the concrete request is merely a refinement, the resource planning application would accept the concrete request for August 13. If, however, the concrete request had been for August 12, the resource planning application may have rejected the concrete request because the previously-accepted portion 325 negates an additional fours hours being scheduled on that day (because the resource would be scheduled to operate in excess of 100% capacity).

As shown in FIG. 3C, the resource planning application distributes the concrete request into a portion 340 on August 13. In this example, the concrete portion 340 would be scheduled in the electronic schedule according to the time slot that specified in the concrete request (12:00-4:00 PM). The portion 340 represents the fours hours requested by the concrete request, which was a refinement of the seven hours originally requested as part of the non-concrete request.

After scheduling the concrete refinement in the electronic schedule, the resource planning application redistributes the remaining three hours from the non-concrete request (seven hours) that were not accounted for by the concrete refinement (four hours). The application does not distribute the remaining three hours into three 1-hour portions (one portion for each day), which would cause the resource to be overbooked on August 13 (scheduled at 125% capacity). Rather, the resource planning application accounts for the portion 340 reserved by the concrete refinement and the previously-accepted portion 325 reserved by the separate concrete request by updating the resource's availability information. Then, the resource planning application redistributes the remaining three hours into portions 351 and 352 using the updated availability information. Thus, the resource planning application schedules the non-concrete portions 351 and 352 into the electronic schedule, but not in the time slot reserved by the previously-accepted concrete request (12:00-3:00 PM on August 12) or by the concrete refinement (12:00-4:00 PM on August 13). In this example, the remaining three hours from the non-concrete request are distributed into a portion 351 on August 12 and a portion on August 14 that have equal heights on the vertical axis 320.

The graphic representations of the resource's capacity in FIGS. 2A-C and 3A-C provide examples of receiving non-concrete requests for a resource's time and receiving subsequent concrete refinements, but the invention is not limited to such examples. Many implementations of the invention may receive the non-concrete requests and the subsequent concrete refinements and then distribute the time differently from the examples described above.

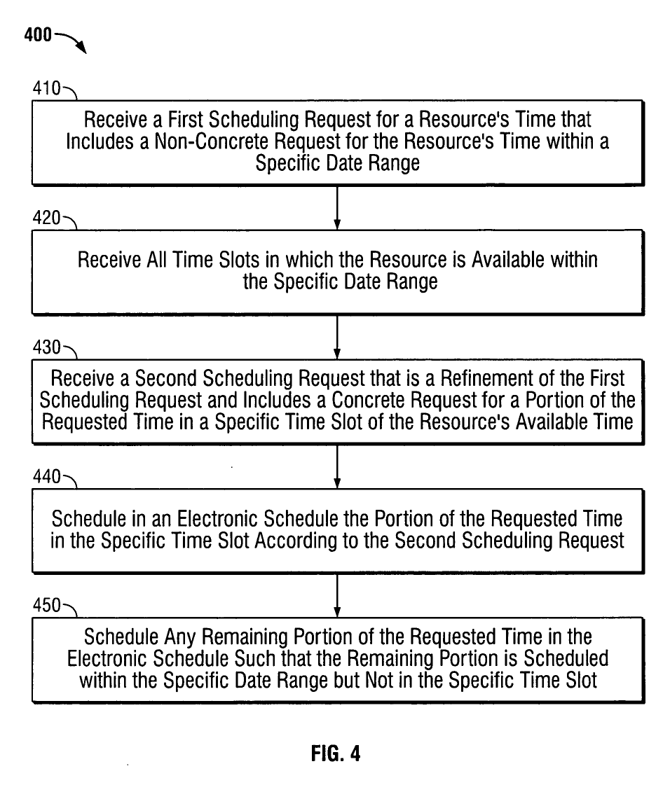

Referring to FIG. 4, some implementations of a method 400 for scheduling use of a resource includes receiving in step 410 a first scheduling request that includes a non-concrete request for the resource's time within a specific date range. For example, the first scheduling request may specify that the resource be scheduled for a requested amount of time (e.g. sixteen hours) sometime within a requested time period (e.g., between July 1, 8:00 AM and July 8, 5:00 PM). In such an example, the requested amount of time (sixteen hours) should be less than a maximum time amount that the resource is available during the requested time period (e.g., total availability for July 1-8 is forty hours); otherwise, the first-scheduling request would be denied due to the resource's unavailability.

Optionally, the method 400 may also include receiving in step 420 all time slots in which the resource is available within the specific date range. Depending on the type of availability information stored in the resource database or the format of the electronic schedule, the resource's availability of time may be maintained as a set of time intervals. For example, the resource database may store the resource's availability information in fifteen-minute intervals (e.g., 8:00-8:15 AM, 8:15-8:30 AM, . . . , 4:45-5:00 PM) such that an assignment may be scheduled to occupy one or more of these intervals. In such an implementation, the resource planning application may receive all unassigned time slots in the specific range, which may be combined to reflect the resource's total availability in that date range.

The method 400 further includes receiving in step 430 a second scheduling request that is a refinement of the first scheduling request and includes a concrete request for a portion of the requested time in a specific time slot of the resource's available time. Continuing with the previous example in which the first scheduling request was for sixteen hours within the dates of July 1-8, the second scheduling request may include concrete date and time facts such as a request for eight hours (out of the originally requested sixteen hours) to be scheduled on July 2 from 12:00-8:00 PM. In this implementation, the resource planning application may refer to the resource's availability to verify that the resource has sufficient capacity on July 2.

The method 400 includes scheduling in step 440 in an electronic schedule the portion of the requested time in the specific time slot according to the second scheduling request. Referring the previous example, the concrete request included a request for eight hours on July 2 from 12:00-8:00 PM, and that time slot would be assigned in the electronic schedule so as to reserve that interval of time according to the second scheduling request.

The method 400 also includes scheduling in step 450 in the electronic schedule the remaining portion of the time requested by the first scheduling request. The remaining portion of time is scheduled within the specific date range, but not in the specific time slot that was scheduled according to the second scheduling request. In one implementation, the resource planning application may receive an update of all time slots in which the resource is available within the specific date range, yet the specific time slot is not included in this updated set because it was reserved according to the second scheduling request. As such, the remaining portion of the time requested by the first scheduling request may be distributed into this set of available time slots without scheduling the resource to operate at a capacity in excess of 100% on any given date. Continuing with the previous example, the remain eight hours (that was not accounted for in the second scheduling request) would be scheduled into the electronic schedule between July 1 and July 8, but not in the specific time slot (July 2 from 12:00-8:00 PM) reserved according to the second scheduling request.

The previously described implementations of the invention refer to the resource's time in terms of hours on a given date, but the invention is not limited to such implementations. Rather, a resource planning application may schedule the resource's time in terms of seconds, minutes, hours, shifts, days, or any other suitable time units.

In addition, some implementations have been described to include a professional consultant or a service technician as the “resource” that has available time. The resource planning application is not limited to such implementations. For example, the resource may be a machine, a person such as a worker, a tool, a workstation, or any other resource that may be fully utilized by efficient scheduling.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations of the invention have been described. Nevertheless, it will be understood that various modifications may be made without departing from the spirit and scope of the invention. Accordingly, other implementations are within the scope of the following claims.

1. A method of scheduling use of a resource, the method comprising:
receiving a first scheduling request for a resource, the first scheduling request specifying that the resource is to be scheduled for a requested amount of time sometime within a requested time period, the requested amount of time being less than a maximum time amount that the resource is available during the requested time period;
receiving a second scheduling request for the resource that refines the first scheduling request, the second scheduling request specifying that a portion of the requested amount of time is to be scheduled in a specific time slot within the requested time period;
scheduling in an electronic schedule the portion of the requested amount of time in the specific time slot; and
scheduling in the electronic schedule a remaining portion of the requested amount of time within the requested time period except within the specific time slot.

2. The method of claim 1, wherein the resource is a person that provides a service requested by the first scheduling request.

3. The method of claim 2, wherein the first scheduling request specifies that the person is to be scheduled for a predetermined number of hours within the requested time period that includes a specific date range.

4. The method of claim 3, wherein the second scheduling request refines the first scheduling request by requesting that a portion of the predetermined number of hours from the first scheduling request is to be scheduled for the specific time slot on a specific date within the date range.

5. The method of claim 1, wherein the first scheduling request specifies that the resource is to be scheduled for a predetermined number of hours within the requested time period that includes a specific date range.

6. The method of claim 5, wherein the second scheduling request refines the first scheduling request by requesting that a portion of the predetermined number of hours from the first scheduling request is to be scheduled for the specific time slot on a specific date within the date range.

7. The method of claim 1, wherein scheduling in the electronic schedule is done to determine a utilization of the resource.

8. A computer program product tangibly embodied in an information carrier, the computer program product including instructions that when executed cause a processor to perform operations comprising:
receive a first scheduling request for a resource, the first scheduling request specifying that the resource is to be scheduled for a requested amount of time sometime within a requested time period, the requested amount of time being less than a maximum time amount that the resource is available during the requested time period;
receive a second scheduling request for the resource that refines the first scheduling request, the second scheduling request specifying that a portion of the requested amount of time is to be scheduled in a specific time slot within the requested time period;
schedule in an electronic schedule the portion of the requested amount of time in the specific time slot; and
schedule in the electronic schedule a remaining portion of the requested amount of time within the requested time period except within the specific time.

9. The computer program product of claim 8, wherein the executable instructions, when executed, further cause the resource planning application to receive all time slots in which the resource is available within the requested time period.
